(19) United States
(12) Patent Application Publication
(10) Pub. No.: US 2026/0370993 A1
(43) Pub. Date: Nov. 19, 2026

(54) SPEAKER SUPPORT STRUCTURE

(71) Applicant: FOSTER ELECTRIC COMPANY, LIMITED, Tokyo (JP)

(72) Inventor: TOMOHISA YOSHIDA, Akishima-shi, Tokyo (JP)

(21) Appl. No.: 19/158,801

(22) PCT Filed: Feb. 21, 2024
(86) PCT No.: PCT/JP2024/006309

§ 371 Date: Aug. 21, 2025

(30) Foreign Application Priority Data
Feb. 22, 2023 (JP) 2023-026737

(51) Int. Cl. H04R 1/02; H04R 9/02

(52) U.S. Cl. CPC H04R 1/026; H04R 9/025

(57) ABSTRACT

A speaker support structure that is capable of reducing manufacturing costs is provided. The speaker support structure S includes a support body 14, a speaker 12, and an elastic body 18. The speaker 12 is supported with respect to the support body 14 by the elastic body 18. Deformation (deformation during vibration) that occurs at the elastic body 18 when the speaker 12 vibrates in a front-rear direction with respect to the support body 14 is mainly bending deformation.

### TECHNICAL FIELD

The present disclosure relates to a speaker support structure.

### BACKGROUND ART

Patent Literature 1 discloses a speaker fixing structure.

In this structure, tube-shaped elastic bodies are fitted to fixing tongues that are provided at both side faces of a case of a box-shaped speaker, and the tube-shaped elastic bodies are inserted into cross-shaped ribs that are attached to a front face panel of a device. By pushing circular bosses that are attached to a rear face cover of the device into the cross-shaped ribs, the elastic bodies are fixed so as to be sandwiched between the front face panel and the rear face cover, and the box-shaped speaker is also fixed at a specified position.

In the aforementioned structure, the box-shaped speaker is supported with respect to the front face panel and the rear face cover by the tube-shaped elastic bodies. When the box-shaped speaker vibrates in a front-rear direction with respect to the front face panel and the rear face cover, the tube-shaped elastic bodies absorb vibration of the box-shaped speaker mainly by being compressed and deformed.

### PRIOR ART LITERATURE

### Patent Literature

Patent Literature 1: Japanese Patent Application Laid-Open (JP-A) No. 2008-244908

### SUMMARY OF THE INVENTION

### Problem to be Solved by the Invention

In the aforementioned structure, there is room for improvement in terms of manufacturing costs.

An object of the present disclosure is to provide a speaker support structure that is capable of reducing manufacturing costs.

### Means for Solving the Problem

A speaker support structure according to a first aspect is a speaker support structure including: a support body; a speaker that emits sound toward a front; and an elastic body that supports the speaker with respect to the support body, wherein deformation that occurs at the elastic body when the speaker vibrates in a front-rear direction with respect to the support body is mainly bending deformation.

In the present aspect, the speaker support structure includes the support body, the speaker, and the elastic body. Since the speaker is supported with respect to the support body by the elastic body, vibration of the speaker can be absorbed.

Further, in the present aspect, deformation that occurs at the elastic body when the speaker vibrates in the front-rear direction with respect to the support body (hereinafter, sometimes referred to as deformation during vibration) is mainly bending deformation.

Thus, a volume of the elastic body can be reduced while maintaining vibration isolation performance.

That is to say, in an aspect in which deformation during vibration is mainly compression deformation, it is necessary to make a front-rear dimension of the elastic body larger in order to obtain required vibration isolation performance. In contrast thereto, when the deformation during vibration is mainly bending deformation as in the present aspect, the front-rear dimension of the elastic body may be smaller. As a result, the volume of the elastic body can be reduced, a size of a mold can be reduced, and manufacturing costs can be reduced.

As described above, according to the present aspect, manufacturing costs can be reduced.

A speaker support structure according to a second aspect is the speaker support structure according to the first aspect, wherein a first held portion, which is a portion of the elastic body that is held by the support body, and a second held portion, which is a portion of the elastic body that is held by the speaker, do not overlap with each other in the front-rear direction.

In the present aspect, the portion of the elastic body that is held by the support body (the first held portion) and the portion of the elastic body that is held by the speaker (the second held portion) do not overlap with each other in the front-rear direction.

Thus, deformation during vibration can be made to be mainly bending deformation.

It should be noted that, although the first held portion is formed at a central portion of the elastic body and the second held portion is formed at an outer peripheral portion of the elastic body in an exemplary embodiment that will be described later, the present aspect is not limited thereto.

A speaker support structure according to a third aspect is the speaker support structure according to the second aspect, wherein an intermediate portion, which is a portion of the elastic body between the first held portion and the second held portion, has an annular shape as viewed from the front-rear direction.

In the present aspect, the intermediate portion, which is a portion of the elastic body between the first held portion and the second held portion, has an annular shape as viewed from the front-rear direction.

Thus, vibration of the speaker can be distributed in a well-balanced manner by the annular intermediate portion.

A speaker support structure according to a fourth aspect is the speaker support structure according to the third aspect, wherein the first held portion is formed at a central portion of the elastic body, and the second held portion is formed at an outer peripheral portion of the elastic body.

In the present aspect, the first held portion is formed at the central portion of the elastic body, and the second held portion is formed at the outer peripheral portion of the elastic body.

Thus, since it is sufficient for an attachment portion that holds the outer peripheral portion of the elastic body to be provided at the speaker, the speaker can be provided with a simple configuration.

A speaker support structure according to a fifth aspect is the speaker support structure according to the fourth aspect, wherein the elastic body includes a center through hole that penetrates the elastic body in the front-rear direction and into which a center pin included at the support body is inserted, and a portion surrounding the center through hole is the first held portion.

In the present aspect, the elastic body includes the center through hole that penetrates the elastic body in the front-rear direction and into which the center pin included at the support body is inserted, and the portion surrounding the center through hole is the first held portion.

Thus, positional deviation between the support body and the elastic body can be prevented.

A speaker support structure according to a sixth aspect is the speaker support structure according to any one of the first aspect to the fifth aspect, wherein a dimension of the elastic body in the front-rear direction is smaller than any dimension of the elastic body in two directions that are perpendicular to the front-rear direction.

In the present aspect, the dimension of the elastic body in the front-rear direction is smaller than any dimension of the elastic body in two directions that are perpendicular to the front-rear direction.

Thus, an amount of material that is used for the elastic body can be reduced, and manufacturing costs can be reduced.

A speaker support structure according to a seventh aspect is the speaker support structure according to any one of the first aspect to the sixth aspect, wherein: the support body or the speaker includes an attachment portion to which the elastic body is attached; the attachment portion includes a placement hole that penetrates the attachment portion in the front-rear direction and in which the elastic body is disposed, and a first prevention portion that is disposed at both front-rear direction sides with respect to the elastic body disposed in the placement hole and that prevents the elastic body from falling out; and the first prevention portion is configured from plural one-side projections that project out toward a central portion of the placement hole and that are disposed at a front-rear direction one side with respect to the elastic body, and plural other-side projections that project out toward the central portion of the placement hole and that are disposed at a front-rear direction other side with respect to the elastic body.

In the present aspect, the support body or the speaker includes the attachment portion to which the elastic body is attached. The attachment portion includes the placement hole in which the elastic body is disposed. Since the placement hole is a hole that penetrates the attachment portion in the front-rear direction, a configuration for preventing the elastic body from falling out from the placement hole to the front and rear is necessary.

In this regard, the attachment portion includes the first prevention portion that is disposed at both front-rear direction sides with respect to the elastic body disposed in the placement hole and that prevents the elastic body from falling out. The first prevention portion is configured from the plural one-side projections and the plural other-side projections. The plural one-side projections project out toward the central portion of the placement hole and are disposed at the front-rear direction one side with respect to the elastic body, and the plural other-side projections project out toward the central portion of the placement hole and are disposed at the front-rear direction other side with respect to the elastic body.

Thus, the elastic body is prevented from falling out from the placement hole of the attachment portion.

A speaker support structure according to an eighth aspect is the speaker support structure according to the seventh aspect, wherein the plural one-side projections and the plural other-side projections do not overlap with each other in the front-rear direction.

In the present aspect, the plural one-side projections and the plural other-side projections do not overlap with each other in the front-rear direction.

Thus, the first prevention portion can be integrally molded using a simple mold.

### BRIEF EXPLANATION OF THE DRAWINGS

FIG. 1 is an exploded perspective view of a speaker system to which a speaker support structure of the present disclosure is applied.

FIG. 2 is a cross-sectional view of the speaker system.

FIG. 3 is an enlarged perspective view illustrating an attachment portion and an elastic body.

FIG. 4 is an enlarged view of the attachment portion viewed from the rear.

FIG. 5 is an enlarged view of the elastic body viewed from the front.

FIG. 6 is an enlarged cross-sectional view of a vicinity of the elastic body in FIG. 2.

FIG. 7 is a cross-sectional view taken through two columnar projections.

FIG. 8(A) is a cross-sectional view illustrating a vibration isolation structure (conventional structure) according to a comparative example, and FIG. 8(B) is a cross-sectional view illustrating a vibration isolation structure (novel structure) according to the present exemplary embodiment.

FIG. 9 is a graph illustrating simulation results for propagated vibration acceleration toward a housing surface.

FIG. 10 is an enlarged cross-sectional view of a vicinity of an elastic body in a speaker support structure according to a modified example.

### EMBODIMENTS FOR IMPLEMENTING THE INVENTION

An exemplary embodiment of a speaker support structure of the present disclosure will be explained below. It should be noted that an arrow Z direction illustrated in the respective drawings indicates a speaker front direction.

### Speaker System 10

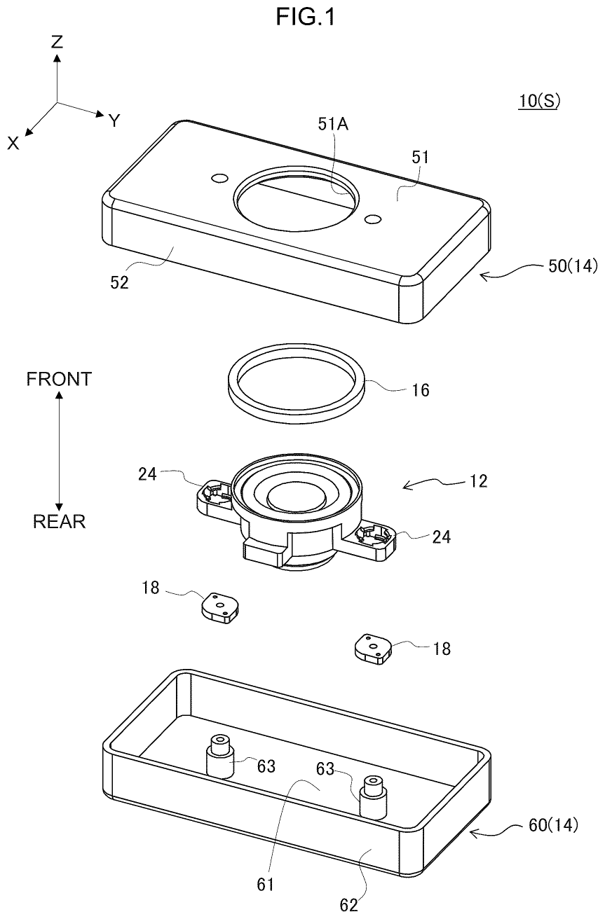

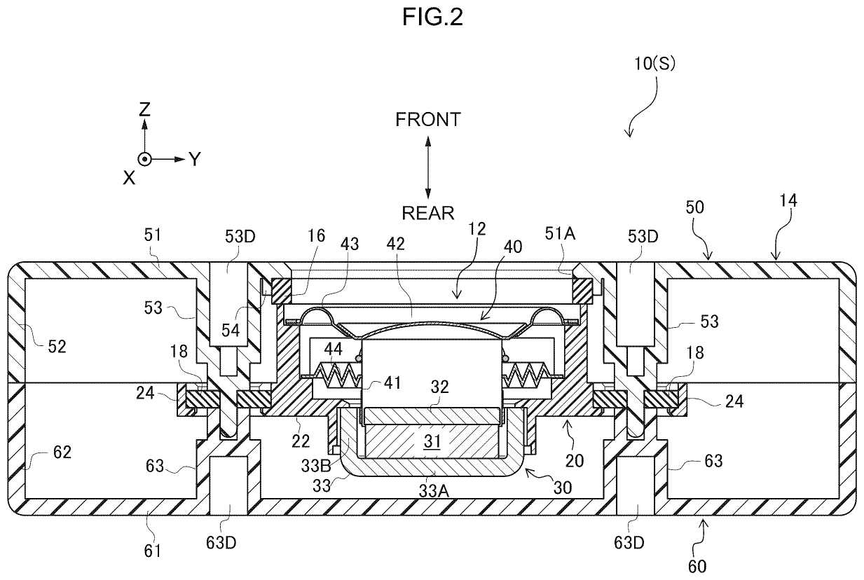

FIG. 1 and FIG. 2 illustrate a speaker system 10 including a speaker support structure S according to the present exemplary embodiment.

The speaker system 10 includes a speaker 12 that emits sound toward the front, a housing (support body) 14 that accommodates the speaker 12, a one-side elastic body 16 that is disposed at the front (a front-rear direction one side) with respect to the speaker 12, and two elastic bodies 18 that support the speaker 12 with respect to the housing 14.

### Speaker 12

As illustrated in FIG. 2, the speaker 12 includes a frame 20, a magnetic circuit 30, and a vibrating portion 40.

The frame 20 is a molded article of a synthetic resin, and is made by injection molding. Specifically, the frame 20 is made with a mold that is configured by only an upper mold and a lower mold. That is to say, the frame 20 has a structure that does not require a mold such as a slide core or the like. A mold opening direction coincides with a speaker front-rear direction.

The frame 20 includes a frame main body 22 and two attachment portions 24.

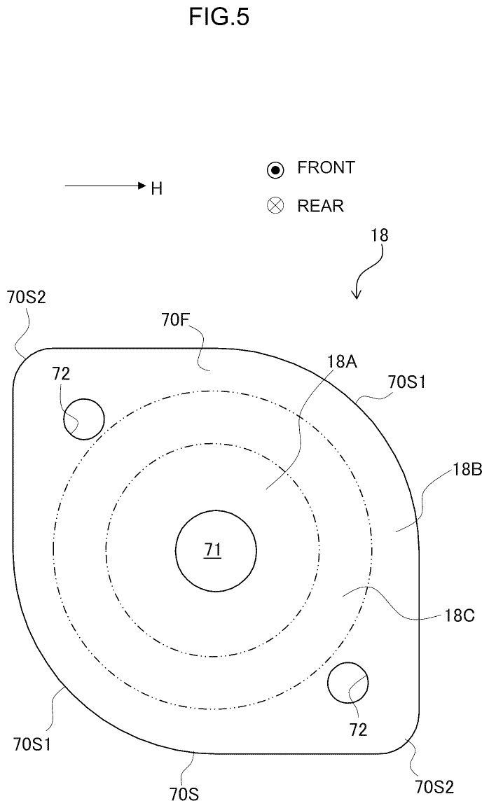

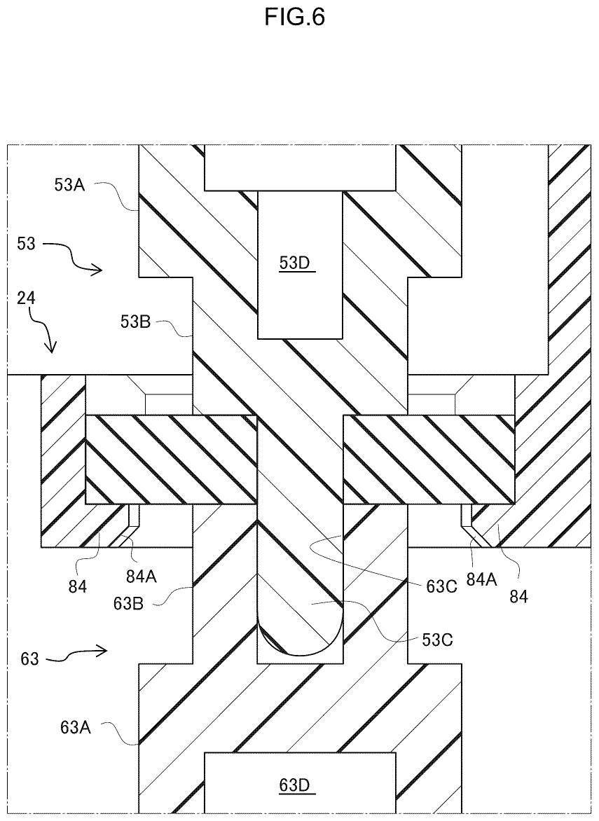

The frame main body 22 supports the magnetic circuit 30 and the vibrating portion 40. The two attachment portions 24 are portions to which the elastic bodies 18 are respectively attached. Each of the two attachment portions 24 has a shape that projects out from the frame main body 22 toward a Y direction outer side (a protruding direction H). The attachment portion 24 is configured so as to hold a second held portion 18B (refer to FIG. 5) configuring an outer peripheral portion of the elastic body 18. It should be noted that two-dotted chain lines in FIG. 5 indicate boundary positions of a first held portion 18A, the second held portion 18B, and an intermediate portion 18C configuring a portion between the first held portion 18A and the second held portion 18B.

A specific configuration of the attachment portions 24 will be described later.

The magnetic circuit 30 includes a magnet 31, a first magnetic member 32, and a second magnetic member 33. The second magnetic member 33 includes a bottom portion 33A and a tube portion 33B. A magnetic gap is formed between the first magnetic member 32 and the second magnetic member 33.

The vibrating portion 40 includes a voice coil 41, a diaphragm 42, an edge 43, and a damper 44. The voice coil 41 is disposed at the magnetic gap. The voice coil 41, which is elastically supported by the damper 44, receives a driving force and vibrates, whereby the diaphragm 42 vibrates, and sound is emitted.

### Housing 14

The housing 14 includes a front wall 51 at which a front opening 51A is formed, a rear wall 61, and a peripheral wall 52, 62. The housing 14 has a rectangular parallelepiped box shape.

The housing 14 is configured from two components, which are a front member 50 and a rear member 60. The front member 50 includes the front wall 51 and a front side portion 52 of the peripheral wall 52, 62. The rear member 60 includes the rear wall 61 and a rear side portion 62 of the peripheral wall 52, 62.

Further, as illustrated in FIG. 2, the front member 50 includes two front side support portions 53, and the rear member 60 includes two rear side support portions 63. The front side support portions 53 and the rear side support portions 63 configure holding portions 53, 63 that hold the elastic bodies 18.

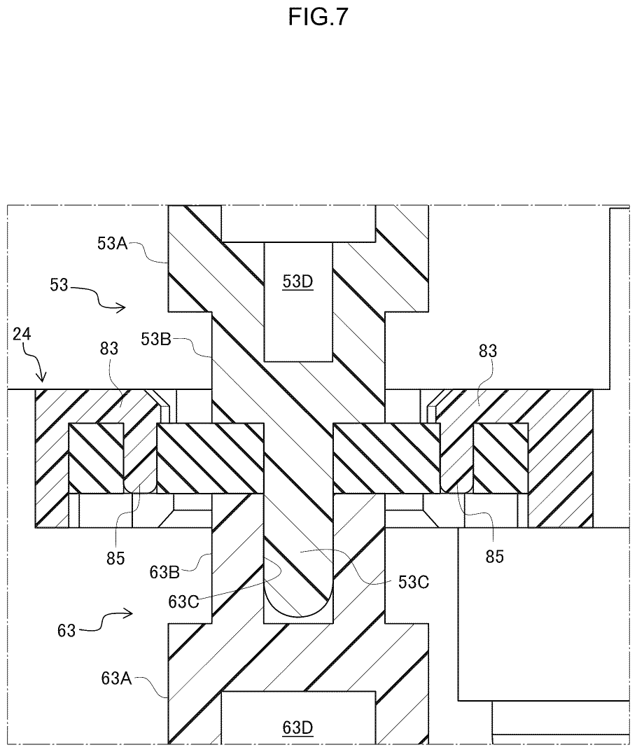

As illustrated in FIG. 6 and FIG. 7, each front side support portion 53 includes a front side base portion 53A, a front side contact portion 53B, and a center pin 53C. Each rear side support portion 63 includes a rear side base portion 63A, a rear side contact portion 63B, and an engagement hole 63C.

The front side support portion 53 has a shape that projects out rearward from the front wall 51. The rear side support portion 63 has a shape that projects out frontward from the rear wall 61. The front side base portion 53A and the rear side base portion 63A each have a columnar shape.

The front side contact portion 53B and the rear side contact portion 63B each have a columnar shape. Diameters of the front side contact portion 53B and the rear side contact portion 63B are smaller than diameters of the front side base portion 53A and the rear side base portion 63A.

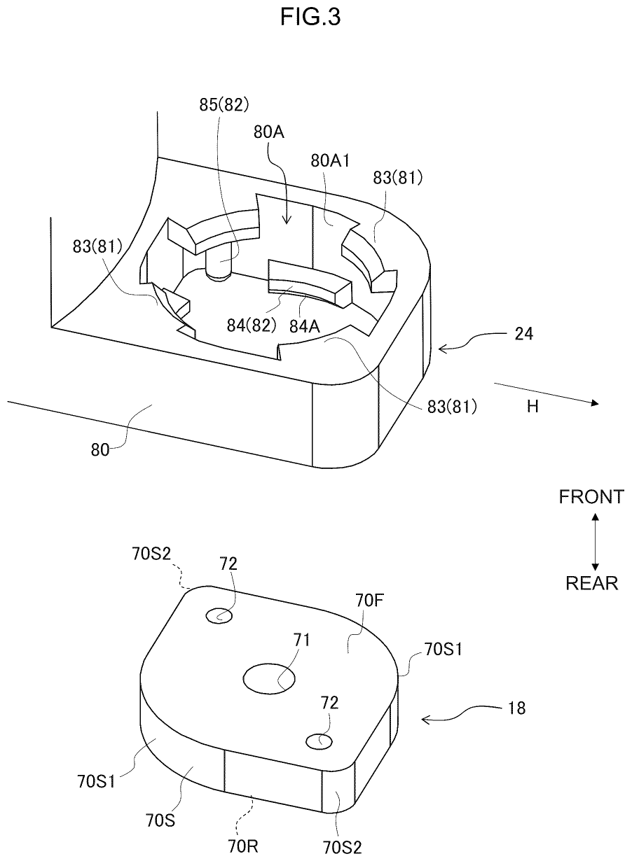

The center pin 53C projects out rearward from the front side contact portion 53B. The center pin 53C passes through a center through hole 71 (refer to FIG. 3) of the elastic body 18, and is inserted into the engagement hole 63C of the rear side support portion 63. The holding portions 53, 63 contact a front face 70F of the first held portion 18A of the elastic body 18 at the front side contact portion 53B, and contact a rear face 70R of the first held portion 18A of the elastic body 18 at the rear side contact portion 63B. Consequently, the housing 14 holds the first held portion 18A (refer to FIG. 5), which is formed at a central portion of the elastic body 18, in a state of being sandwiched from front and rear directions by the holding portions 53, 63.

As illustrated in FIG. 2, a cavity portion 53D that is open at a front side is formed at an interior of the front side base portion 53A and the front side contact portion 53B of the front side support portion 53. A cavity portion 63D that is open at a rear side is formed at an interior of the rear side base portion 63A of the rear side support portion 63.

As illustrated in FIG. 2, the front member 50 includes a circumferential projecting portion 54 at which the one-side elastic body 16 is disposed. The circumferential projecting portion 54 projects out toward the rear side from a rear face of the front wall 51, and is a projecting portion formed in a circumferential shape. The one-side elastic body 16 is disposed at an inner side of the circumferential projecting portion 54. The circumferential projecting portion 54 is positioned between the two front side support portions 53 in the Y direction.

### One-Side Elastic Body 16

The one-side elastic body 16 is disposed between the speaker 12 and the front wall 51 of the housing 14. The one-side elastic body 16 is annular. An inner diameter of the one-side elastic body 16 is substantially the same as a diameter of the front opening 51A. When the one-side elastic body 16 is cut along a plane that is perpendicular to a circumferential direction, a cross-sectional shape thereof is rectangular.

### Elastic Bodies 18

The two elastic bodies 18 have the same configuration as each other.

The elastic bodies 18 are held by the attachment portions 24 of the frame 20, and are held by the holding portions 53, 63 of the housing 14. Consequently, the two elastic bodies 18 function so as to support the speaker 12 with respect to the housing 14, and to suppress propagation of vibration of the speaker 12 to the housing 14. A material of the elastic bodies 18 is not particularly limited, but is, for example, EPDM (ethylene propylene diene rubber).

### Specific Configurations of Elastic Bodies 18 and Attachment Portions 24

Next, specific configurations of the elastic bodies 18 and the attachment portions 24 will be explained.

As illustrated in FIG. 3, each elastic body 18 includes the front face 70F, the rear face 70R, and a side face 70S. The front face 70F is a flat face having a normal direction facing in the front direction. The rear face 70R is a flat face having normal direction facing in the rear direction. The side face 70S is a face having normal directions facing in directions perpendicular to the front-rear direction.

The side face 70S includes a pair of circular arc portions 70S1 (general portions 70S1) and a pair of right angle portions 70S2 (expansion portions 70S2).

In directions perpendicular to the front-rear direction, the pair of circular arc portions 70S1 are formed at positions that face each other in a direction that is oblique with respect to both the protruding direction H and a protruding perpendicular direction (a direction perpendicular to both the front-rear direction and the protruding direction H; an X direction) across the central portion of the elastic body 18. Among directions perpendicular to the front-rear direction, the pair of right angle portions 70S2 face each other in a direction perpendicular to the direction in which the pair of circular arc portions 70S1 face each other, across the central portion of the elastic body 18.

Consequently, a dimension of the elastic body 18 in the direction in which the pair of right angle portions 70S2 face each other is larger than that in the direction in which the pair of circular arc portions 70S1 face each other. Among directions perpendicular to the front-rear direction, a direction in which the dimension of the elastic body 18 is at a maximum is referred to as an expansion direction, and the expansion direction is a direction that is oblique with respect to the protruding direction H among directions perpendicular to the front-rear direction, and is specifically a direction that intersects therewith at an angle of 45 degrees.

The elastic body 18 has the first hole 71. The first hole 71 is a center through hole through which the center pin 53C (refer to FIG. 6 and FIG. 7) passes. The first hole 71 is a hole having the same shape as a cross-sectional shape of the center pin 53C, and specifically is a circular hole. A diameter of the first hole 71 is substantially the same as a diameter of the center pin 53C. The first hole 71 is formed at a center of gravity position of the elastic body 18.

The elastic body 18 includes two second holes (through holes) 72. The second holes 72 are holes into which columnar projections 85 (refer to FIG. 7) of the attachment portion 24 are inserted. The second holes 72 are holes having the same shape as a cross-sectional shape of the columnar projections 85, and specifically are circular holes. Diameters of the second holes 72 are substantially the same as diameters of the columnar projections 85.

The two second holes 72 are formed at positions that are symmetrical across the central portion of the elastic body 18. A direction linking the two second holes 72 is the same direction as the expansion direction of the elastic body 18. A distance between the first hole 71 and each of the second holes 72 is larger than the diameter of the first hole 71.

As illustrated in FIG. 3, each attachment portion 24 includes a base portion 80 at which a placement hole 80A is formed, first prevention portions 81, and second prevention portions 82.

A shape of the placement hole 80A as viewed from the front-rear direction is substantially the same as the shape of the elastic body 18 as viewed from the front-rear direction. Thus, in a state in which the elastic body 18 is disposed in the placement hole 80A, the side face 70S of the elastic body 18 is in a state in which it is in contact with an inner face 80A1 of the placement hole 80A over an entire circumference thereof.

The base portion 80 has a shape that is asymmetric with respect to the direction (the protruding perpendicular direction; the X direction) that is perpendicular to both the front-rear direction and the protruding direction H. Specifically, as illustrated in FIG. 1, the base portion 80 of the attachment portion 24 at a +Y direction side has a shape that is expanded at a +X direction side thereof, and the base portion 80 of the attachment portion 24 at a −Y direction side has a shape that is expanded at a −X direction side thereof.

The first prevention portions 81 are disposed at both front-rear direction sides of the elastic body 18 that has been disposed in the placement hole 80A, and prevent the elastic body 18 from falling out.

The first prevention portions 81 include plural one-side projections 83 and plural other-side projections 84. A number of the one-side projections 83 and a number of the other-side projections 84 are the same number, and in the present exemplary embodiment, they are both four.

The plural one-side projections 83 and the plural other-side projections 84 are both projections that project out from the inner face 80A1 of the placement hole 80A toward a central portion of the placement hole 80A.

The plural one-side projections 83 project out from front end portions of the inner face 80A1 of the placement hole 80A.

The plural other-side projections 84 project out from rear end portions of the inner face 80A1 of the placement hole 80A.

A front-rear direction distance between rear faces of the one-side projections 83 and front faces of the other-side projections 84 is approximately the same as a front-rear direction dimension of the elastic body 18.

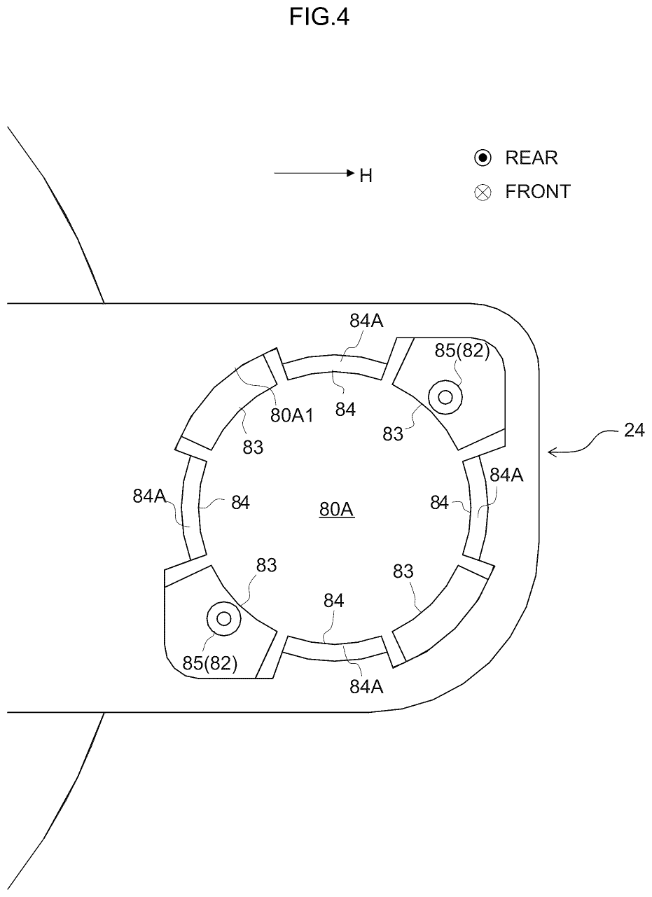

As illustrated in FIG. 4, leading ends of the one-side projections 83 and the other-side projections 84 (ends at a central portion side of the placement hole 80A) are formed in arc shapes that are centered on the central portion of the placement hole 80A, as viewed from the front-rear direction. Consequently, the leading ends of the plural one-side projections 83 and the leading ends of the plural other-side projections 84 are positioned in a circumferential shape that is centered on the central portion of the placement hole 80A, as viewed from the front-rear direction.

The elastic body 18 is held at an outer peripheral portion thereof by the first prevention portions 81 of the attachment portion 24. In other words, when a portion of the elastic body 18 that is held by the speaker 12 is referred to as the second held portion 18B, the second held portion 18B is formed at the outer peripheral portion of the elastic body 18 (refer to FIG. 5).

As illustrated in FIG. 4, the plural one-side projections 83 and the plural other-side projections 84 are disposed so as not to overlap with each other in the front-rear direction (a thickness direction of the elastic body 18). Thus, the first prevention portions 81 can be formed of one component using a simple mold. The plural one-side projections 83 and the plural other-side projections 84 are disposed differently from each other in the circumferential direction.

As illustrated in FIG. 4, the second prevention portions 82 include plural (two) columnar projections 85.

The two columnar projections 85 project out rearward from plural (two) one-side projections 83, which are a portion of the plural (four) one-side projections 83.

The two one-side projections 83 at which the columnar projections 85 are formed are two one-side projections 83 formed at positions at opposite sides with a center of the placement hole 80A interposed therebetween. Since the plural columnar projections 85 are at positions at opposite sides with the center of the placement hole 80A interposed therebetween, falling-out of the elastic body 18 can be effectively suppressed.

The columnar projections 85 each have a columnar shape. It should be noted that the columnar projections are not limited to this shape, and may have a cross-shaped boss shape or a cylindrical shape. Further, a stopper portion (for example, a flange) for preventing falling-out of the elastic body may be formed at a leading end of the columnar projection.

Inclined faces 84A facing obliquely rearward are respectively formed at the other-side projections 84. Since the elastic body 18 is attached to the attachment portion 24 from the rear side, the inclined faces 84A of the other-side projections 84 facilitate an operation for attaching the elastic body 18 to the attachment portion 24.

It should be noted that, although similar inclined faces are also respectively formed at the one-side projections 83 (refer to FIG. 3), the inclined faces of the one-side projections 83 are unnecessary from the standpoint of facilitating the operation for attaching the elastic body 18 to the attachment portion 24.

### Operation and Effects

Next, operation and effects of the present exemplary embodiment will be explained.

As illustrated in FIG. 1, in the present exemplary embodiment, the speaker support structure S includes the support body (housing) 14, the speaker 12, and the elastic body 18. Since the speaker 12 is supported with respect to the support body 14 by the elastic body 18, vibration of the speaker 12 can be absorbed. In other words, by providing a vibration isolation structure between the speaker 12, which is the origin of the vibration, and the housing 14 with respect to a vibration propagation path from the speaker 12 to the support body 14, vibration can be prevented from propagating over a wide range of the support body 14.

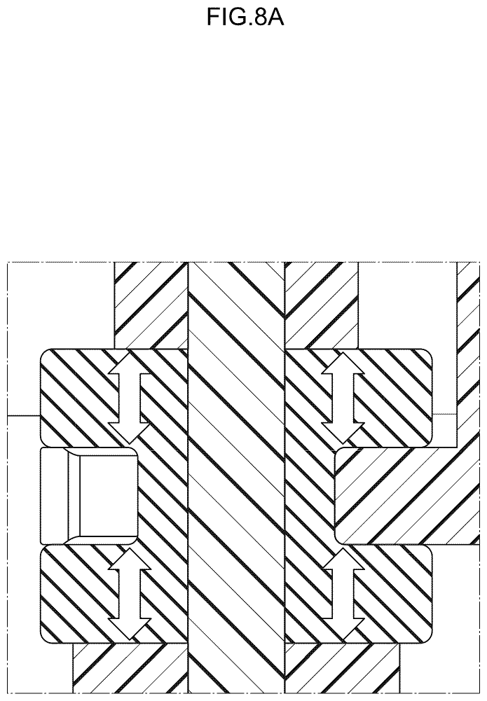

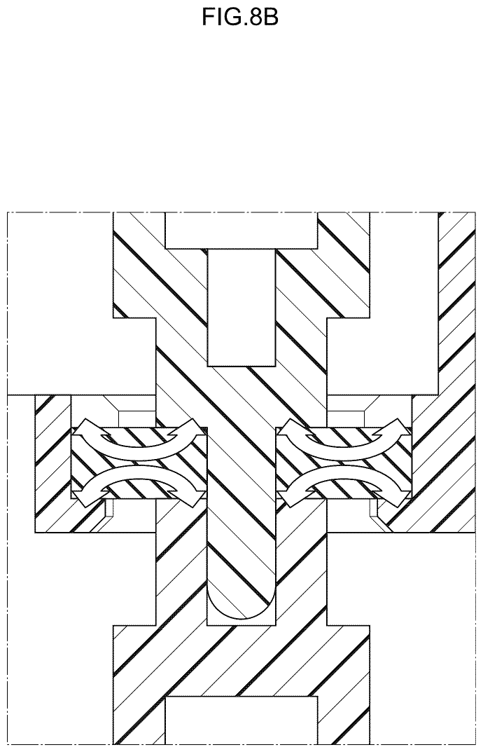

Further, as illustrated in FIG. 2 and FIG. 8(B), in the present exemplary embodiment, deformation (deformation during vibration) that occurs at the elastic body 18 when the speaker 12 vibrates in the front-rear direction with respect to the support body 14 is mainly bending deformation. More specifically, vibration of the speaker 12 in the front-rear direction is transmitted to the elastic body 18, and the elastic body 18 undergoes bending deformation at the outer side and the inner side. Consequently, vibration of the speaker 12 in the front-rear direction is absorbed, and is not transmitted to the support component 14 (support body; housing).

Thus, a volume of the elastic body 18 can be reduced while maintaining vibration isolation performance.

That is to say, in an embodiment in which deformation during vibration is mainly compression deformation (refer to FIG. 8(A)), it is necessary to make a front-rear dimension of the elastic body 18 larger in order to obtain required vibration isolation performance. In contrast thereto, when the deformation during vibration is mainly bending deformation as in the present exemplary embodiment, the front-rear dimension of the elastic body 18 may be smaller. As a result, the volume of the elastic body 18 can be reduced, a size of a mold can be reduced, and manufacturing costs can be reduced.

Further, as illustrated in FIG. 5, in the present exemplary embodiment, the portion (the first held portion 18A) of the elastic body 18 that is held by the support body 14 and the portion (the second held portion 18B) of the elastic body 18 that is held by the speaker 12 are disposed so as not to overlap with each other in the front-rear direction.

Thus, deformation during vibration can be made to be mainly bending deformation.

Further, as illustrated in FIG. 5, in the present exemplary embodiment, the intermediate portion 18C, which is a portion of the elastic body 18 that is between the first held portion 18A and the second held portion 18B, is annular as viewed from the front-rear direction.

Thus, vibration of the speaker 12 can be distributed in a well-balanced manner by the annular intermediate portion 18C.

Further, as illustrated in FIG. 5, in the present exemplary embodiment, the first held portion 18A is formed at the central portion of the elastic body 18, and the second held portion 18B is formed at the outer peripheral portion of the elastic body 18.

Thus, since it is sufficient for the attachment portion 24 that holds the outer peripheral portion of the elastic body 18 to be provided at the speaker 12, the speaker 12 can be provided with a simple configuration.

Further, as illustrated in FIG. 5, in the present exemplary embodiment, the elastic body 18 includes the center through hole (first hole) 71 that penetrates the elastic body 18 in the front-rear direction and into which the center pin 53C (refer to FIG. 6) included at the support body 14 is inserted, and a portion surrounding the center through hole 71 is the first held portion 18A.

Thus, positional deviation between the support body 14 and the elastic body 18 can be prevented.

Further, as illustrated in FIG. 3, in the present exemplary embodiment, the front-rear direction dimension of the elastic body 18 is smaller than any of the dimensions of the elastic body 18 in two directions that are perpendicular to the front-rear direction.

Thus, an amount of material that is used for the elastic body 18 can be reduced, and manufacturing costs can be reduced.

Further, as illustrated in FIG. 3, in the present exemplary embodiment, the speaker 12 includes the attachment portion 24 to which the elastic body 18 is attached. The attachment portion 24 includes the placement hole 80A in which the elastic body 18 is disposed. Since the placement hole 80A is a hole that penetrates the attachment portion 24 in the front-rear direction, a configuration for preventing the elastic body 18 from falling out from the placement hole 80A to the front and rear is necessary.

In this regard, the attachment portion 24 includes the first prevention portions 81 that are disposed at both front-rear direction sides with respect to the elastic body 18 disposed in the placement hole 80A, and that prevent the elastic body 18 from falling out. The first prevention portions 81 are configured from the plural one-side projections 83 and the plural other-side projections 84. The plural one-side projections 83 project out toward the central portion of the placement hole 80A and are disposed at a front-rear direction one side with respect to the elastic body 18, and the plural other-side projections 84 project out toward the central portion of the placement hole 80A and are disposed at a front-rear direction other side with respect to the elastic body 18.

Thus, the elastic body 18 is prevented from falling out from the placement hole 80A of the attachment portion 24.

Further, as illustrated in FIG. 4, in the present exemplary embodiment, the plural one-side projections 83 and the plural other-side projections 84 are disposed so as not to overlap with each other in the front-rear direction.

Thus, the attachment portion 24 including the first prevention portions 81 can be integrally molded using a simple mold. As a result, manufacturing costs can be reduced, compared to a case in which the attachment portion 24 is molded separately as two components.

Further, as illustrated in FIG. 3 and FIG. 7, in the present exemplary embodiment, the attachment portion 24 includes the second prevention portions 82 that prevent the elastic body 18 from falling out. The second prevention portions 82 are configured from one or plural columnar projections 85 projecting out from plural one-side projections 83. The one or plural columnar projections 85 are inserted into one or plural through holes (second holes) 72 that penetrate the elastic body 18 in the front-rear direction.

Thus, the elastic body 18 can be further prevented from falling out.

In particular, when the deformation during vibration is mainly bending deformation, the elastic body 18 becomes more likely to fall out. That is to say, when the deformation during vibration is mainly bending deformation, a force that causes the outer peripheral portion of the elastic body 18 to be displaced toward the inner side direction is exerted due to, for example, an impact load. As a result, the elastic body 18 becomes more likely to fall out, even with the first prevention portions 81.

However, in the present exemplary embodiment, since the columnar projections 85 are disposed in the through holes 72 that penetrate the elastic body 18 in the front-rear direction, displacement of the outer peripheral portion of the elastic body 18 toward the inner side direction can be suppressed, and the elastic body 18 can be prevented from falling out.

Further, as illustrated in FIG. 3, in the present exemplary embodiment, the attachment portion 24 has a shape that protrudes out in the protruding direction H (Y direction outer side), which is a direction that is perpendicular to the front-rear direction. The one or plural through holes 72 include two through holes 72 that are separated in a direction that is oblique with respect to the protruding direction H across the center of the elastic body 18, and do not include two through holes 72 that are separated in a direction that is parallel to the protruding direction H (Y direction outer side) across the center of the elastic body 18.

Thus, an increase in the size of the attachment portion 24 can be avoided, and falling-out of the elastic body 18 can be efficiently prevented.

Further, as illustrated in FIG. 4 and FIG. 6, in the present exemplary embodiment, the inclined surfaces 84A that are inclined toward the central portion of the placement hole 80A at the front-rear direction one side and that facilitate placement of the elastic body 18 in the placement hole 80A are formed at the plural other-side projections 84.

Thus, the elastic body 18 can be easily attached to the attachment portion 24 from the front-rear direction other side.

Further, as illustrated in FIG. 4, in the present exemplary embodiment, the attachment portion 24 has a shape that protrudes out in the protruding direction H (Y direction outer side), which is a direction that is perpendicular to the front-rear direction. The number of each of the one-side projections 83 and the other-side projections 84 is four. The four other-side projections 84 are configured from two other-side projections 84 that face the protruding direction H (Y direction outer side), and two other-side projections 84 that face the protruding perpendicular direction (a direction that is perpendicular to both the front-rear direction and the protruding direction H; the X direction). The four one-side projections 83 and the four other-side projections 84 are alternately formed along the circumferential direction.

Since the one-side projections 83 face obliquely with respect to the protruding direction (Y direction outer side), the one-side projections 83 can be formed to be large while avoiding an increase in size of the attachment portion 24.

Further, in the present exemplary embodiment, since the one-side projections 83 from which the columnar projections 85 project face obliquely with respect to the protruding direction H (Y direction outer side) as illustrated in FIG. 4, an increase in size of the attachment portion 24 can be avoided.

Further, as illustrated in FIG. 2, in the present exemplary embodiment, the speaker support structure S further includes the one-side elastic body 16 that is disposed between a one-side wall (the front wall 51) of the support body 14 that is disposed at a front-rear direction one side of the speaker 12, and the speaker 12.

Thus, displacement of the speaker 12 toward the front-rear direction one side (front side) is suppressed by the one-side elastic body 16. As a result, falling out of the elastic body 18 from the placement hole 80A toward the front-rear direction other side (rear side) is suppressed.

### Simulation Results

Next, simulation results regarding vibration isolation performance will be explained.

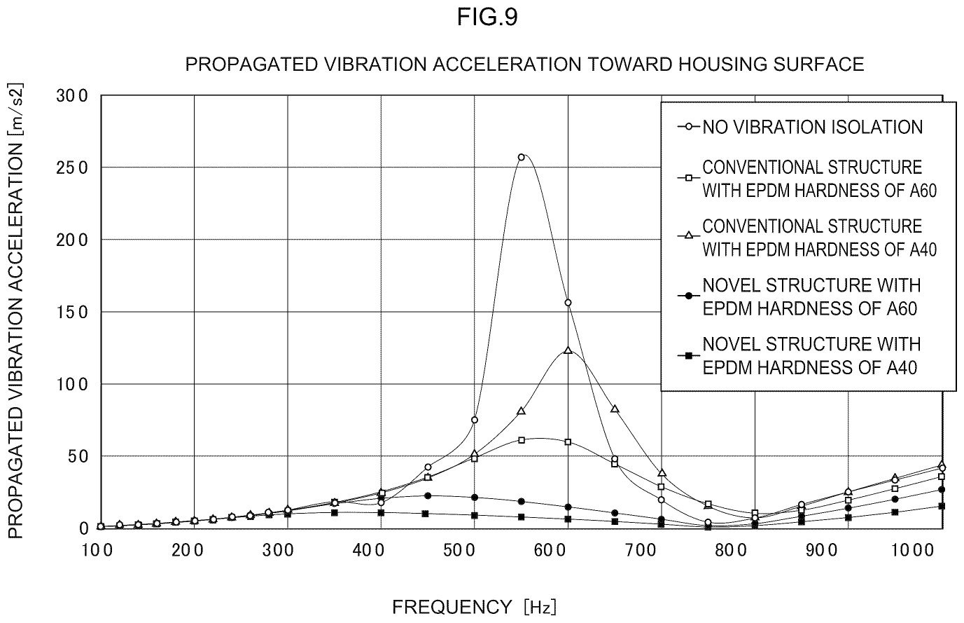

FIG. 9 is a graph illustrating simulation results for propagated vibration acceleration toward a housing surface. The “conventional structure” in FIG. 9 is the structure illustrated in FIG. 8(A), the “novel structure” is the structure of the aforementioned exemplary embodiment illustrated in FIG. 8(B), and the “no vibration isolation” is a support structure in which no vibration isolation structure is provided. EPDM (ethylene propylene diene rubber) was used as elastic bodies for the conventional structure and the novel structure. Further, simulations of two patterns with different hardnesses were performed for each of the structures.

As can be understood from the results shown in FIG. 9, higher vibration isolation performance was obtained in the novel structure than in the conventional structure. Since the volume of the elastic body is smaller in the novel structure than in the conventional structure, it can be regarded that higher vibration isolation performance can be realized while reducing a material cost of the elastic body, according to the novel structure.

### Supplementary Explanation

A preferable exemplary embodiment of the present disclosure has been explained above, but the present disclosure is not limited to the aforementioned exemplary embodiment. Just to be sure, supplementation will be provided below.

Although the speaker support structure S includes two elastic bodies 18 in the aforementioned exemplary embodiment, the present disclosure is not limited thereto. The speaker support structure may include one elastic body, or may include three or more elastic bodies.

Although the entire frame 20 is a structure that does not require a mold such as a slide core or the like in the aforementioned exemplary embodiment, the present disclosure is not limited thereto. For example, the attachment portion of the frame may be a structure that does not require a mold such as a slide core or the like, and portions of the frame other than the attachment portion may be a structure that does require a mold such as a slide core or the like.

Furthermore, the attachment portion is not limited to the aforementioned configuration, and may be a structure that requires a mold such as a slide core or the like.

Although the speaker 12 has the configuration illustrated in FIG. 2 (the configuration of a cone-type speaker) in the aforementioned exemplary embodiment, a specific configuration of the speaker of the present disclosure is not limited thereto.

Although the support body 14 is the box-shaped housing 14 in the aforementioned exemplary embodiment, the support body of the present disclosure is not limited thereto.

Although the speaker 12 includes the attachment portion 24 in the aforementioned exemplary embodiment, the attachment portion of the present disclosure is not limited thereto. The support body may include the “attachment portion” of the present disclosure.

Although an example in which the front-rear direction one side is the front side and the front-rear direction other side is the rear side has been explained in the aforementioned exemplary embodiment, the present disclosure is not limited thereto. The front-rear direction one side may be the rear side, and the front-rear direction other side may be the front side.

Although numbers of the plural one-side projections 83 and the plural other-side projections 84 of the first prevention portions 81 are the same in the aforementioned exemplary embodiment, the present disclosure is not limited thereto, and the numbers thereof may be different from each other.

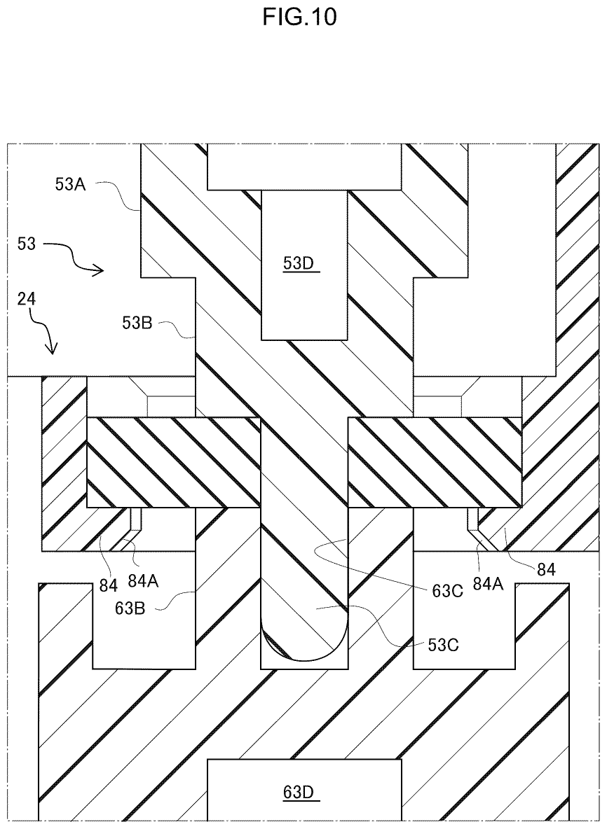

Lastly, a speaker support structure according to a modified example will be explained with reference to FIG. 10.

When the speaker 12 is excessively displaced in the front-rear direction due to an impact or the like from the exterior, there is a risk that the elastic body 18 may fall out from the placement hole 80A of the attachment portion 24.

In this regard, in the modified example, as illustrated in FIG. 10, the housing (support body) 14 includes a regulating portion 63E that is provided at a position that the speaker 12 contacts when the speaker 12 has moved toward the front-rear direction other side (rear side). The regulating portion 63E prevents excessive displacement of the speaker 12 toward the front-rear direction other side (rear side).

Thus, excessive displacement of the speaker 12 toward the front-rear direction other side (rear side) is prevented by the regulating portion 63E, and as a result, the elastic body 18 is prevented from falling out from the placement hole 80A of the attachment portion 24.

Further, in the modified example, as illustrated in FIG. 10, the regulating portion 63E is provided at a position that the attachment portion 24 of the speaker 12 contacts.

Thus, by devising structures of holding portions 53, 163 of the support body 14, which hold the elastic body 18, and the attachment portion 24 of the speaker 12, the regulating portion 63E can be provided. Further, since the regulating portion is provided close to the elastic body, intervention of other components can be reduced as much as possible. As a result, since there is no stacking of dimensional tolerances, the regulating portion can be formed with good precision in a limited space.

Further, similarly as in the aforementioned exemplary embodiment, in the modified example, the one-side elastic body 16 is disposed at the front (the front-rear direction one side) with respect to the speaker 12. More specifically, the one-side elastic body 16 is disposed between the front wall 51 and the speaker 12 (refer to FIG. 2). Thus, displacement of the speaker 12 toward the front (the front-rear direction one side) is suppressed. However, no elastic body is disposed at the rear (the front-rear direction other side) with respect to the speaker 12. Thus, it is preferable for the regulating portion 63E to be provided at least at the front-rear direction other side (at the rear side) with respect to the speaker 12, as in the modified example illustrated in FIG. 10.

The structure of the modified example will be explained more specifically below.

The regulating portion 63E is formed so as to project out further toward the front side than a front face of the rear side base portion 63A. Two regulating portions 63E are formed with respect to a single rear side support portion 163. The two regulating portions 63E are positioned at one side in the Y direction and at the other side in the Y direction with respect to the rear side contact portion 63B.

Leading ends (front ends) of the regulating portions 63E and the attachment portion 24 face each other in the front-rear direction. A distance in the front-rear direction between the regulating portions 63E and the attachment portion 24 is shorter than a distance in the front-rear direction between the magnetic circuit 30 of the speaker 12 and the rear wall 61.

It should be noted that the regulating portion of the present disclosure is not limited to the specific structure that is illustrated in FIG. 10 and that has been explained above. For example, the regulating portion may be provided at a front side of the support body with respect to the speaker, or may be provided at both the front side and the rear side. Further, the regulating portion of the support body may be provided at a position that is contacted by a portion of the speaker other than the attachment portion.

Further, the regulating portion 63E having a projecting shape is provided at the support body 14 side in FIG. 10, but, by providing a portion having a projecting shape at the speaker 12 side, a portion of the support body 14 that contacts the portion having a projecting shape may be made to function as the regulating portion.

Furthermore, one regulating portion or three or more regulating portions may be provided at each of the pair of holding portions 53, 163. In a case in which one regulating portion is formed, it is preferably provided in an annular shape. Further, although two regulating portions 63E that are aligned in the Y direction are explained in FIG. 10, the direction in which the two regulating portions 63 are aligned is not limited to the Y direction.

### EXPLANATION OF REFERENCE SYMBOLS

10: Speaker System
12: Speaker
14: Housing (Support Body)
16: One-Side Elastic Body
18: Elastic Body
18A: First Held Portion
18B: Second Held Portion
18C: Intermediate Portion
24: Attachment Portion
30: Magnetic Circuit
40: Vibrating Portion
50: Front Member
51: Front Wall (One-Side Wall)
53C: Center Pin
63E: Regulating Portion
71: First Hole (Center Through Hole)
72: Second Hole (Through Hole)
80A: Placement Hole
81: First Prevention Portion
82: Second Prevention Portion
83: One-Side Projection (One-Side Projection)
84: Other-Side Projection (Other-Side Projection)
84A: Inclined Face
85: Columnar Projection

1. A speaker support structure comprising:
a support body;
a speaker that emits sound toward a front; and
an elastic body that supports the speaker with respect to the support body,
wherein deformation that occurs at the elastic body when the speaker vibrates in a front-rear direction with respect to the support body is mainly bending deformation.

2. The speaker support structure according to claim 1, wherein a first held portion, which is a portion of the elastic body that is held by the support body, and a second held portion, which is a portion of the elastic body that is held by the speaker, do not overlap with each other in the front-rear direction.

3. The speaker support structure according to claim 2, wherein an intermediate portion, which is a portion of the elastic body between the first held portion and the second held portion, has an annular shape as viewed from the front-rear direction.

4. The speaker support structure according to claim 3, wherein:
the first held portion is formed at a central portion of the elastic body; and
the second held portion is formed at an outer peripheral portion of the elastic body.

5. The speaker support structure according to claim 4, wherein:
the elastic body includes a center through hole that penetrates the elastic body in the front-rear direction and into which a center pin included at the support body is inserted; and
a portion surrounding the center through hole is the first held portion.

6. The speaker support structure according to claim 1, wherein a dimension of the elastic body in the front-rear direction is smaller than any dimension of the elastic body in two directions that are perpendicular to the front-rear direction.

7. The speaker support structure according to claim 1, wherein:
the support body or the speaker includes an attachment portion to which the elastic body is attached;
the attachment portion includes:
a placement hole that penetrates the attachment portion in the front-rear direction and in which the elastic body is disposed, and
a first prevention portion that is disposed at both front-rear direction sides with respect to the elastic body disposed in the placement hole and that prevents the elastic body from falling out; and
the first prevention portion is configured from:
a plurality of one-side projections that project out toward a central portion of the placement hole and that are disposed at a front-rear direction one side with respect to the elastic body, and
a plurality of other-side projections that project out toward the central portion of the placement hole and that are disposed at a front-rear direction other side with respect to the elastic body.

8. The speaker support structure according to claim 7, wherein the plurality of one-side projections and the plurality of other-side projections do not overlap with each other in the front-rear direction.
